(19) United States
(12) Patent Application Publication
(10) Pub. No.: US 2018/0197216 A1
(43) Pub. Date: Jul. 12, 2018

(54) Method for Managing a Smart Enterprise Network

(71) Applicant: Vijay Sundhar, Saratoga, CA (US)

(72) Inventor: Vijay Sundhar, Saratoga, CA (US)

(21) Appl. No.: 15/401,974

(22) Filed: Jan. 9, 2017

(51) Int. Cl. G06Q 30/06

(52) U.S. Cl. CPC G06Q 30/0601

(57) ABSTRACT

A method for managing a smart enterprise network to bring enterprises, vendors, and individuals together allows for the efficient exchange of applied technologies and industry strategies for problems, and provide a platform for users to exchange goods and services. Each enterprise account on the network can access a plurality of executable functions managed by the central server with the corresponding personal computing (PC) device, wherein the executable functions include a function for correlating internal operational data to the enterprise profile data, a function for correlating enterprise profile data to external market data, a function for facilitating market participation between buyers and sellers, and a function for facilitating transactions for technology and services. These executable functions allow the enterprise account to have better knowledge and presence within respective fields. Vendors and individuals can list or procure goods and services through market participation to enhance the overall value of the network.

### FIELD OF THE INVENTION

The present invention relates generally to a global network connecting enterprises, vendors (software, hardware and services) and individuals. More specifically, the present invention relates to components and how these entities are connected and enabled by cloud based networking, mobile, Big-Data and social network for enterprises, vendors, and individuals (independents) to produce and consume business value through collaboration, information sharing, and personalization.

### BACKGROUND OF THE INVENTION

Today, enterprises rely on private and public knowledge to assess business and technology decisions. Through engaging consultants, research analysts, other literature, and the Internet, these enterprises try to find the most pertinent information regarding their industry to keep at the top of their field while providing the best products and solutions possible. The enterprise may find recent relevant information though these methods; however, most of the information is valuable only when related to their profile or context. An enterprise profile describes the enterprise business capabilities required for enterprises to conduct its business and technologies and their relationship used to support those functions. All parties and components in the network are linked through the profile. Linking external events to enterprise context takes time and would be at a time lapse from the time the event was published due to an employee or group of employees having to locate the information and source manually. In most enterprises, this may not be possible because of information silo or information dispersed across the organization. This process may take days, weeks or months after the event has been published to bring the enterprise the new and relevant information based on internal events and events in their industry. Having visibility to their current state, knowing of any impact and options to respond in real-time due to market events will provide enterprises a huge competitive advantage. Currently, there is a gap in the market for a service that brings relevant internal and industry information and applies to the enterprise context quickly and efficiently for impact analysis, recommendations and strategic insights.

The present invention seeks to fulfill this need in the enterprise information market by presenting a method for enterprises to manage their profile centrally and to acquire the most recent, relevant information and solutions to their industry as it is published internally by systems, externally and input into the network. This method presents a network where enterprises, individuals and vendors can share knowledge and resources in a manner that would benefit all parties in real time. The present invention allows for real time event distribution to enterprises (smart enterprise event) where they would receive the details of the new relevant technology advances, security breach potentials, and other industry events simultaneously limiting the possibility of falling behind in industry. Thus, not only providing visibility to industry events, the network proactively alerts and proposes options if impacted due to these events and trends. Another aspect of the present invention is a marketplace where enterprises, individuals and vendors can advertise and provide products, and services to one another. A network such as the present invention will be able to help provide the industry with standards for industries with varying methods and parts for products or services. The present invention enables an open network for provider of products and services to compete for opportunities and provides enterprises with possible options quickly and efficiently to meet their needs. Another aspect of the present invention is that enterprises can extend the visibility to their profile to vendors and individuals for strategic purposes and to create “win-win” opportunities through social network between enterprises, vendors and individuals.

### BRIEF DESCRIPTION OF THE DRAWINGS

FIG. 1 is a flowchart detailing the general process of the present invention.

FIG. 2 is a flowchart detailing the introduction of new profile datum to the central server and the conditionals for displaying data to the arbitrary user account.

FIG. 3 is a flowchart detailing the function for facilitating market participation between buyers and sellers.

FIG. 4 is a flowchart detailing the function for facilitating transactions for technologies and services.

FIG. 5 is a flowchart detailing the function for correlating internal operational data to the enterprise profile data.

FIG. 6 is a flowchart detailing the function for correlating enterprise profile data to external market data, more specifically the function for sending an obsolete notification for technologies incorporated by a specific enterprise profile.

FIG. 7 is a flowchart detailing the function for correlating enterprise profile data to external market data, more specifically the function for notifying a specific enterprise profile of a technological failure of technology implemented by the specific enterprise profile.

FIG. 8 is a flowchart detailing the function for correlating enterprise profile data to external market data, more specifically the function for alerting a specific enterprise profile of a merger between two other enterprise profiles.

FIG. 9 is a flowchart the function for correlating enterprise profile data to external market data, more specifically the function for sending business efficiency trends to the user of the specific enterprise profile.

### DETAIL DESCRIPTIONS OF THE INVENTION

All illustrations of the drawings are for the purpose of describing selected versions of the present invention and are not intended to limit the scope of the present invention.

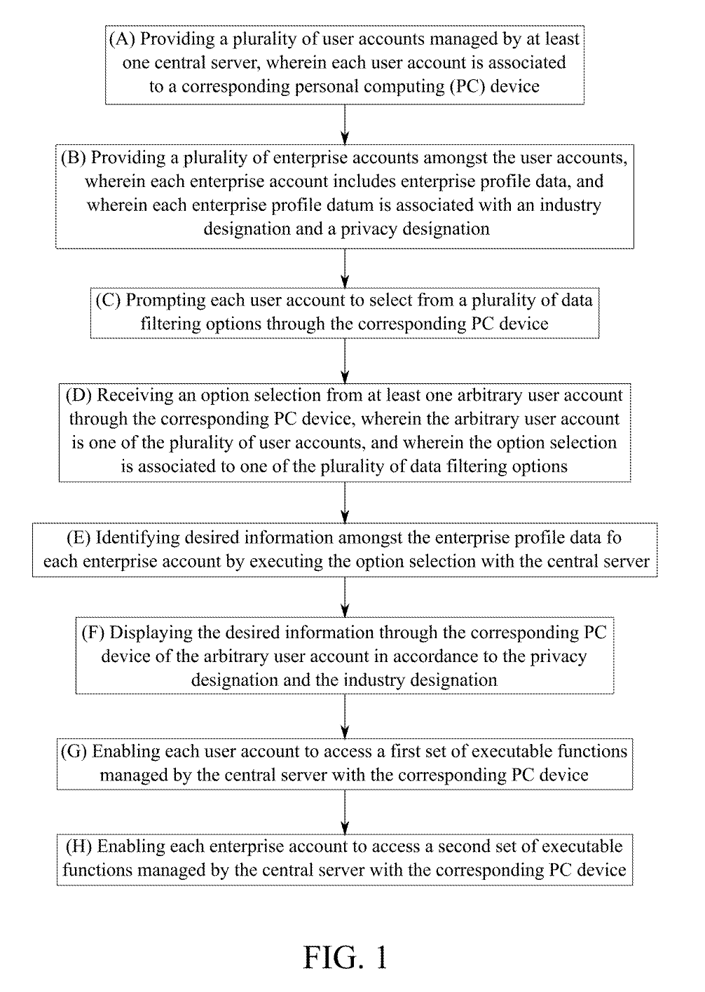

The present invention is a method for managing a smart enterprise network to bring enterprises, vendors, and individuals together. The present invention allows for the efficient exchange of applied technologies, industry strategies for problems, and provide a platform for users to exchange goods and services. As shown in FIG. 1, the least one central server manages a plurality of user accounts, in order to allow users to access the smart enterprise network (Step A Each user account is associated with a corresponding personal computing (PC) device, such that the user is able to be identified by the central server access to be granted access to the smart enterprise network. The corresponding personal computing device can be, but is not limited to, a personal computer, a laptop, a smartphone, and a portable tablet device.

In accordance to the preferred embodiment of the present invention, a plurality of enterprise accounts is provided amongst the plurality of user accounts (Step B). The enterprise accounts are accounts associated with specific businesses for a variety of industries. Each enterprise account includes enterprise profile data on the central server. The enterprise profile data includes, but is not limited to, biographical data, business capabilities, strategies, assets, and plans of the enterprise. Business capabilities refer to the functional hierarchy, organizational hierarchy or a combination of both for the enterprise. Strategies refer to the business strategy for operational and growth objectives. Assets refer to the property owned by the enterprise, and plans refer to the execution of the strategies through use of the assets available to the enterprise. Each of the enterprise profile datum is associated with an industry designation and a privacy designation as identifiers for each profile datum. The industry designation allows the enterprise account to be located through search parameters to allow users to find relevant enterprise profiles. The privacy designation allows the user of the enterprise account to set a private or public designation for each of the enterprise profile datum in order to allow the user of the enterprise account to control the dissemination of information able to be presented to other users.

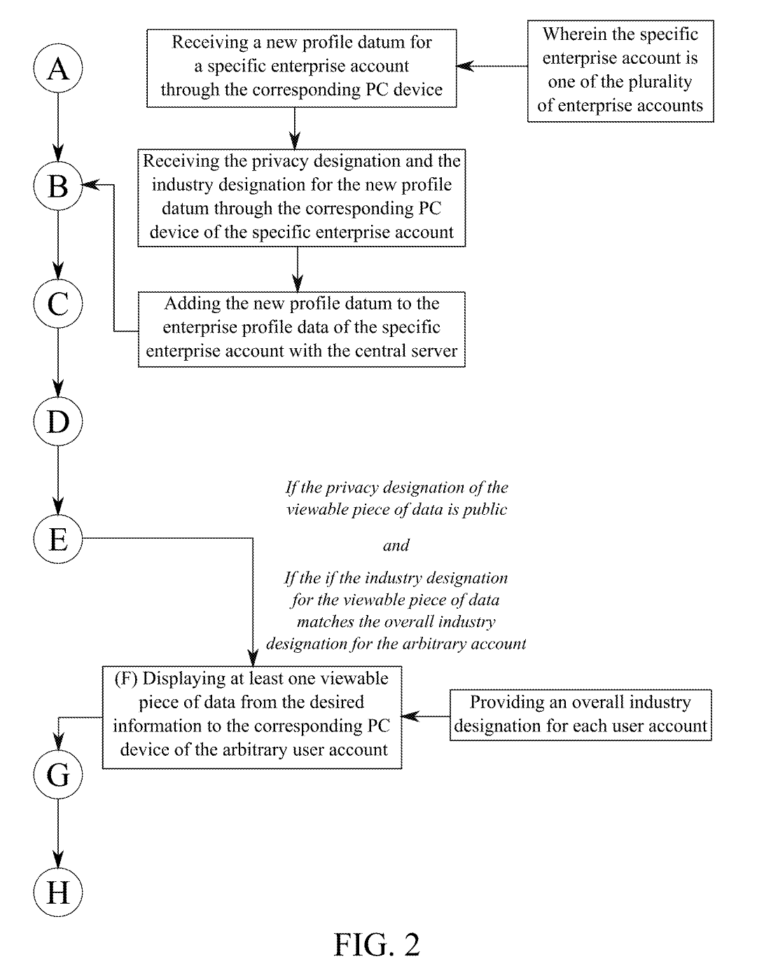

To introduce new profile data to the central server, the new profile datum for a specific enterprise account is received through the corresponding PC device, in accordance to FIG. 2. The specific enterprise account is one of the enterprise accounts seeking to update or change the enterprise profile data with the new profile datum. Simultaneously, the privacy designation and the industry designation for the new profile datum is received through the corresponding PC device of the specific enterprise account. The new profile datum is added to the enterprise profile data of the specific enterprise account with the central server and, therefore, updating the enterprise profile data on the central server to be accessed by other user accounts and implemented in executable functions for the specific enterprise account.

In order to access the enterprise profile data, each user account is prompted to select from a plurality of data filtering options through the corresponding PC device (Step C), detailed in FIG. 1. The data filtering options allow the user to specify parameters to search for related information to the chosen parameters in order to filter enterprise profile data for related enterprise accounts from the plurality of enterprise accounts. An option selection, associated with one the plurality of data filtering options, is received from at least one arbitrary user account through the corresponding PC device (Step D). The at least one arbitrary user account is one of the plurality of user accounts attempting to access the enterprise profile data. Desired information amongst the enterprise profile data for each enterprise account is identified by executing the option selection with the central server (Step E). The desired information is then displayed through the corresponding PC device of the arbitrary user account in accordance to the privacy designation and the industry designation. The desired information amongst the enterprise profile data for each enterprise accounts is then displayed to the arbitrary user account (Step F), in order to allow the arbitrary user account to view and assess the desired information extracted from the enterprise profile data of each enterprise profile data related to the inquiry of the arbitrary user account. For example, the arbitrary user account may desire information from a textile industry. The user of the arbitrary user account chooses an option selection for textile, where a plurality of associated enterprise accounts is determined associated with the textile industry, and the present invention then outputs enterprise profile data for different enterprise accounts that are associated with the textile industry.

More specifically, an overall industry designation is provided for each user account, in accordance to FIG. 2. At least one viewable piece of data from the desired information is displayed to the corresponding PC device of the arbitrary user account, if the privacy designation of the viewable piece of data is public and if the industry designation for the viewable piece of data matches the overall industry designation for the arbitrary user account.

Further in accordance to the preferred embodiment of the present invention, each user account is enabled access to a first set of executable functions managed by the central server with the corresponding PC device (Step G), as shown in FIG. 1. The first set of executable functions include, but is not limited to, a function for facilitating market participation between vendors and sellers and a function for facilitating transactions for technology and services. The executable functions allow each of the user accounts to gain and exchange knowledge through the market participation and transactions in order to improve the business practices of that user account, as well as acquiring or disseminating knowledge, technology, and approaches to industry related issues.

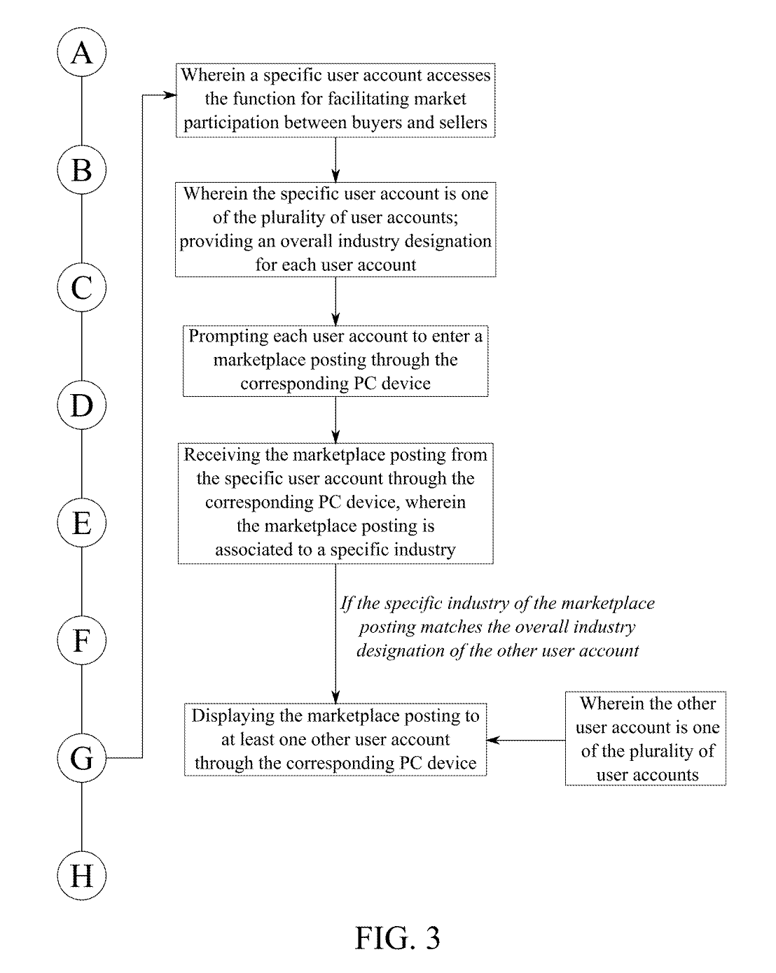

The present invention seeks to bring individuals and vendors together to exchange information, good and services. As mentioned, the present invention includes the function for facilitating market participation between buyers and sellers, as shown in FIG. 3. Each user account includes an overall industry designation in order to filter results for potential buyers and sellers within a user's industry. Prior to a specific user account accessing the function for facilitating market participation, each user account is prompted to enter a marketplace posting through the corresponding PC device when seeking to sell information, goods or services. The marketplace posting, associated with the specific industry, is received through the corresponding PC of the specific user account. The specific user is one of the plurality of user accounts. The marketplace posting is displayed to at least one other user account through the corresponding PC device, if the specific industry matches the overall industry designation of the other user account of the plurality of user accounts. Therefore, any user account, enterprise, vendor, or individual, is able to create market listings on a virtual marketplace to exchange information, goods, and services.

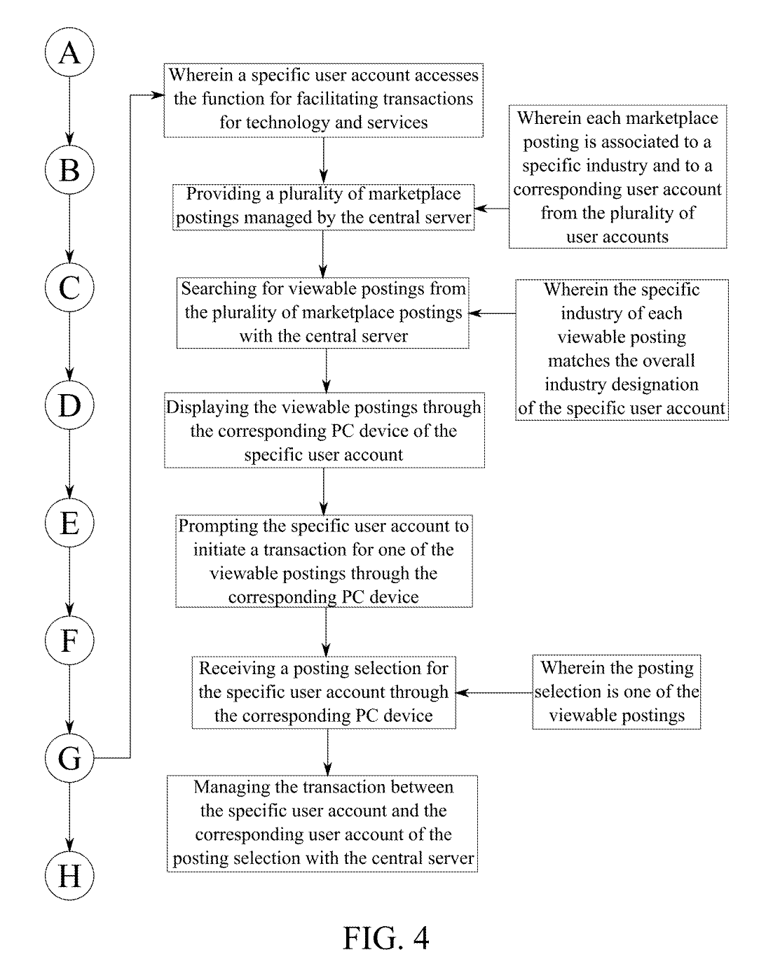

Further, the user for a specific user account is able access the function for facilitating transactions and services during Step G, in accordance to FIG. 4. Each marketplace posting is associated to a specific industry and to a corresponding user account in order to sort and identify marketplace postings for a specific user account to view desirable marketplace postings. When this function is initiated, the central server searches for viewable postings from a plurality of marketplace postings, wherein the specific industry of each viewable posting matches the overall industry designation of a corresponding user account from the plurality of user accounts. Subsequently, the viewable postings are displayed through the corresponding PC device of the specific user account. The specific user account is then prompted to initiate a transaction for one of the viewable postings through the corresponding PC device, such that the specific user account is able to confirm the transaction. A posting selection for the specific user account is received through the corresponding PC device, wherein the posting selection is one of the viewable postings that the user selected to proceed with the transaction. Finally, a transaction is managed between the specific user account and the corresponding user account of the posting selection with the central server to exchange the goods and services effectively and efficiently.

Further in accordance to the preferred embodiment of the present invention, each enterprise account is enabled access to a second set of executable functions managed by the central server with the corresponding PC device (Step H), as shown in FIG. 1. The second set of executable functions include, but is not limited to, a function for correlating internal operational data to the enterprise profile data and a function for correlating enterprise profile data to external market data. The second set of executable functions allow each of the enterprise accounts to further gain and exchange knowledge to improve the practices of that enterprise account, as well as acquiring or disseminating knowledge, technology, and approaches to industry related issues.

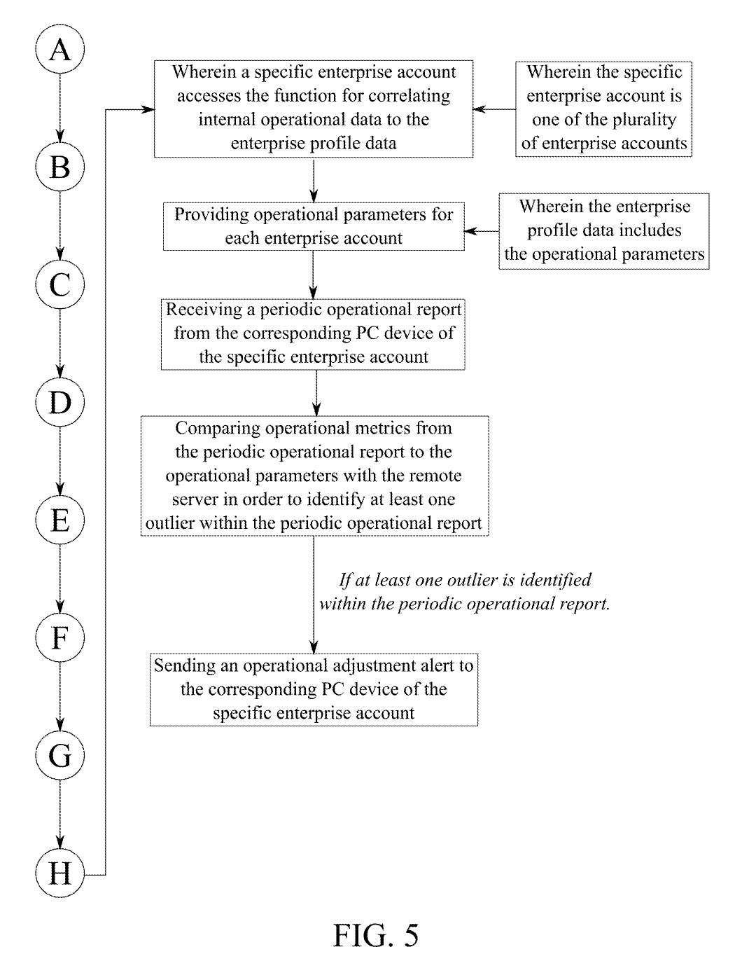

For instances where a specific enterprise account accesses the function for correlating internal operational data during Step H, operational parameters for each enterprise accounts are included within the enterprise profile data, wherein the specific enterprise account is one of the plurality of enterprise accounts, as shown in FIG. 5. The operational parameters are set target goals the enterprise desires to achieve for production of goods or services for the enterprise. A periodic operational report is received from the corresponding PC device of the specific enterprise account. The periodic operational report is a report for profits, expenses, and current lifecycle positions over a specific timeframe. Operational metrics from the period operations report, such as production rates, profits, expenses, and completion dates of tasks or significant events for the lifecycle, are then compared to the operational parameters with the remote server in order to identify at least one outlier within the periodic operational report, and, therefore, determine if the enterprise is achieving set target goals. An outlier is a notable statistical variance in the operational metrics from the operational parameters. An operational adjustment alert is then sent to the corresponding PC of the specific enterprise account, if at least one outlier is identified within the periodic operational report. Therefore, the user of the specific enterprise account will be notified if any adjustments need to be made to the execution of the business model for that enterprise to return the operational metrics within ideal operational parameters.

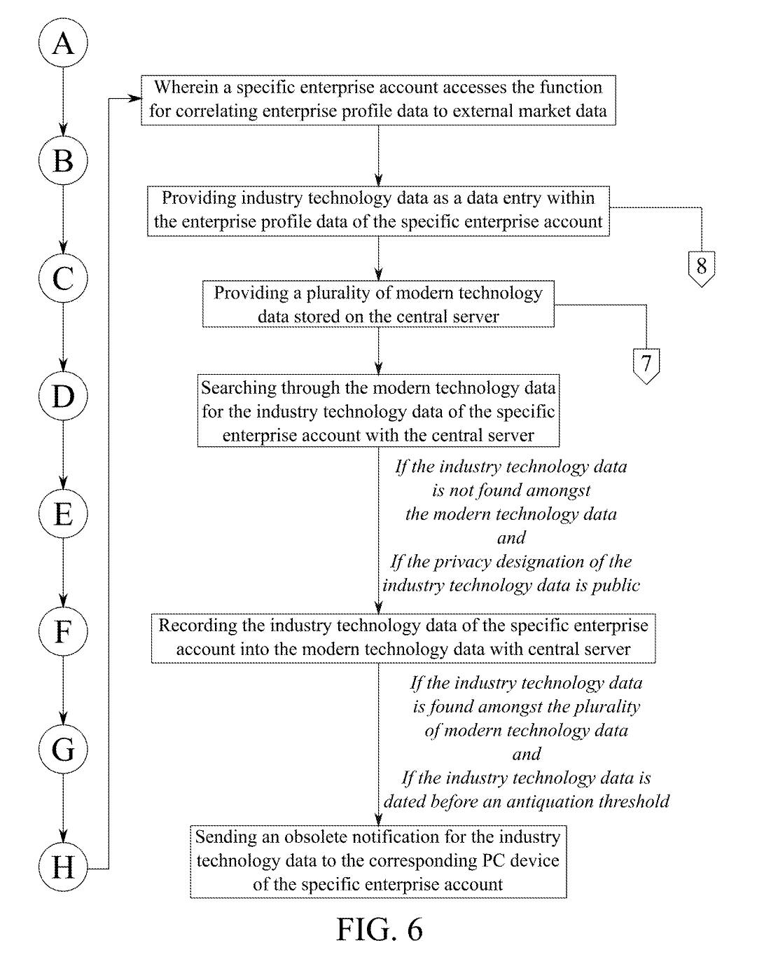

For instances where the specific enterprise account accesses the function for correlating enterprise profile data to external market data during Step H, industry technology data is provided as a data entry within the enterprise profile of the specific enterprise account, as shown in FIG. 6. The industry technology data refers to technologies that the enterprise incorporates in general operation activities. The central server searches through a plurality of modern technology data stored within the central server for industry technology data of the specific enterprise account. The modern technology data is information is known technology uses within the industry, for example a specific catalyst for chemical reactions or a ring spinning machine for textiles. If the industry technology data is not found amongst the modern technology data and if the privacy designation of the industry technology data is public, the industry technology data of the specific enterprise account is recorded into the modern technology data with the central server, in order to allow information about the new technology to be disseminated to other user accounts.

Further in accordance to FIG. 6, the present invention allows enterprises to monitor the technology implemented within operational procedures of the enterprise to compare the implemented technologies with known technologies for updating, re-purposing, or retiring the implemented technologies. For example, an obsolete notification for the industry technology is sent to the corresponding PC device of the specific enterprise account, if the industry technology data is found amongst the plurality of modern technology data and if the industry technology data is dated before an antiquation threshold. The antiquation threshold is a date stored within the plurality of modern technology data for when a technology is outdated for the application due to an introduction of significantly more efficient and productive technologies.

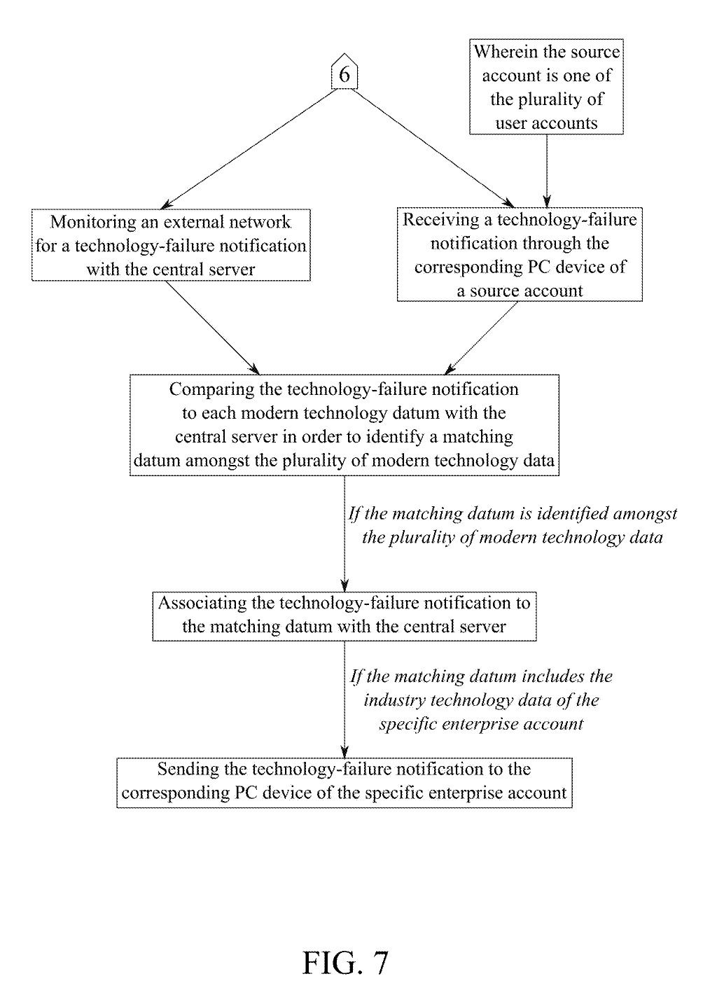

Another aspect of the present invention allows the user of an enterprise account to be alerted for technology failures for a specific technology that the enterprise implements for business practices, as detailed in FIG. 7. In one embodiment of the present invention, an external network is monitored for a technology-failure notification with the central server. The external network is preferred to be the Internet; however, the data may be sourced from any applicable network. The technology-failure notification may be determined through article headlines, keyword tags, metadata, or any applicable information to determine that an incident has occurred with a given technology. In an alternate embodiment of the present invention, the technology-failure notification is received the corresponding PC device of a source account, wherein the source account is one of the plurality of user accounts. The user of the source account inputs the technology-failure notification manually to spread knowledge of the failure to other users. The technology-failure notification is then compared to each modern technology datum with the central server in order to identify a matching datum amongst the plurality of modern technology data. The technology-failure notification is then associated with the matching datum with the central server to allow the users view a record of failure incidents using a given technology, if the matching datum is identified amongst the plurality of modern technology data. The technology-failure notification is then sent to the corresponding PC device of the specific enterprise account, if the matching datum includes the industry technology data of the specific enterprise account. Therefore, the user of the specific enterprise account is alerted to any failures for implemented technologies and may act accordingly to prevent or avoid the similar failures from occurring.

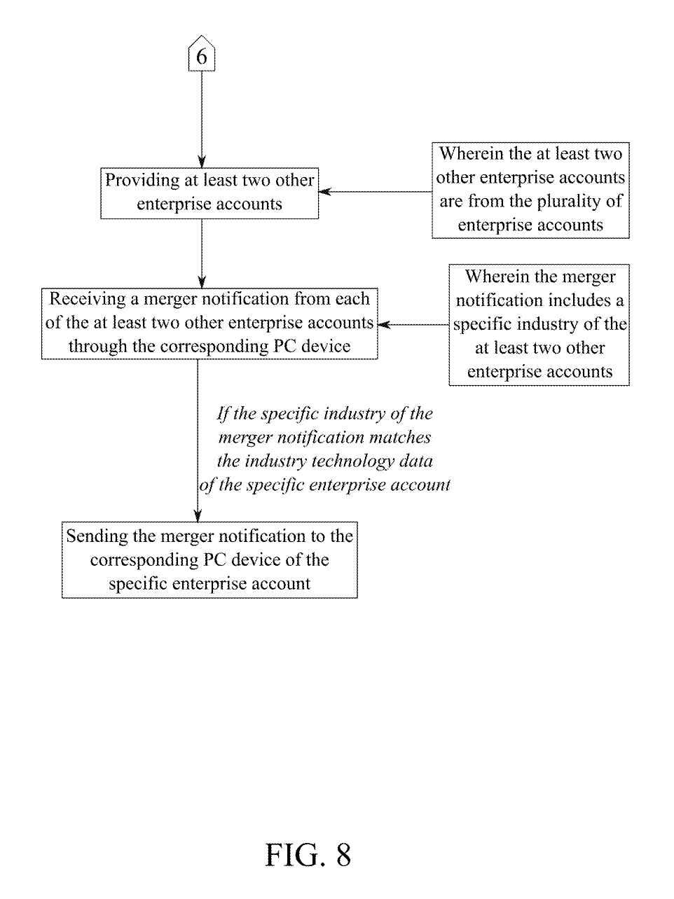

Further assisting a user of an specific enterprise account, the present invention allows the specific enterprise account to be able to monitor the movements of other competing enterprises, such as mergers, acquisitions, or dissolution of other enterprises. In one embodiment of the present invention, for example, at least two other enterprise accounts from the plurality of enterprise accounts are provided on the central server that are seeking to participate in a merger, as detailed in FIG. 8. A merger notification from each of the at least two other enterprise accounts is received through the corresponding PC device, in order to notify the central server of the merger. The merger notification includes a specific industry of the at least two other enterprise accounts in order to determine which enterprise accounts are notified. The merger notification is then sent to the corresponding PC device of the specific enterprise account to alert the user of the specific enterprise account of the merger, if the specific industry of the merger notification matches the industry technology data of the specific enterprise profile.

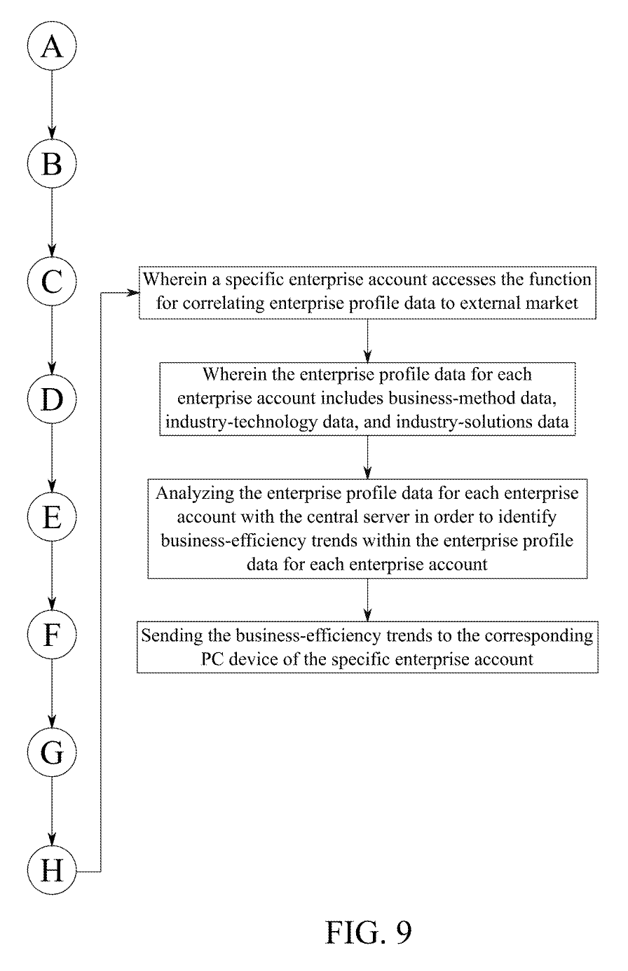

Further in accordance to the preferred embodiment of the present invention, users of enterprise accounts are able to view general trends provided in public datum within the enterprise profile data, as shown in FIG. 9. For this, the specific enterprise account accesses the function for correlating enterprise profile data to external market data in Step H, wherein the enterprise profile data includes business method data, industry-technology data and industry-solutions data. The enterprise profile data for each enterprise account is then analyzed with the central server in order to identify business-efficiency trends within the enterprise profile data for each enterprise account. Business-efficiency trends provide the user of the enterprise account insight into the efficiency and effectiveness for the practices for any enterprise account or an average for enterprise accounts using specific technologies or business practices, such as revenue or production quantities using the specific technology or business practices over time. The business-efficiency trends are then sent to corresponding PC device of the specific enterprise account for the user of the specific enterprise account to consider for the operations of that enterprise.

Although the invention has been explained in relation to its preferred embodiment, it is to be understood that many other possible modifications and variations can be made without departing from the spirit and scope of the invention as hereinafter claimed.

What is claimed is:

1. A method for managing a smart enterprise network comprises the steps of:
(A) providing a plurality of user accounts managed by at least one central server, wherein each user account is associated to a corresponding personal computing (PC) device;
(B) providing a plurality of enterprise accounts amongst the user accounts, wherein each enterprise account includes enterprise profile data, and wherein each enterprise profile datum is associated with an industry designation and a privacy designation;
(C) prompting each user account to select from a plurality of data filtering options through the corresponding PC device;
(D) receiving an option selection from at least one arbitrary user account through the corresponding PC device, wherein the arbitrary user account is one of the plurality of user accounts, and wherein the option selection is associated to one of the plurality of data filtering options;
(E) identifying desired information amongst the enterprise profile data for each enterprise account by executing the option selection with the central server;
(F) displaying the desired information through the corresponding PC device of the arbitrary user account in accordance to the privacy designation and the industry designation;
(G) enabling each user account to access a first set of executable functions managed by the central server with the corresponding PC device, wherein the first set of executable functions include a function for facilitating market participation between buyers and sellers and a function for facilitating transactions for technology and services; and
(H) enabling each enterprise account to access a second set of executable functions managed by the central server with the corresponding PC device, wherein the second set of executable functions include a function for correlating internal operational data to the enterprise profile data and a function for correlating enterprise profile data to external market data.

2. The method for managing a smart enterprise network as claim in claim 1 comprises the steps of:
receiving a new profile datum for a specific enterprise account through the corresponding PC device, wherein the specific enterprise account is one of the plurality of enterprise accounts;
receiving the privacy designation and the industry designation for the new profile datum through the corresponding PC device of the specific enterprise account; and
adding the new profile datum to the enterprise profile data of the specific enterprise account with the central server.

3. The method for managing a smart enterprise network, as claim in claim 1, comprises the steps of:
providing an overall industry designation for each user account; and
displaying at least one viewable piece of data from the desired information to the corresponding PC device of the arbitrary user account,
if the privacy designation of the viewable piece of data is public,
and if the if the industry designation for the viewable piece of data matches the overall industry designation for the arbitrary user account.

4. The method for managing a smart enterprise network, as claimed in claim 1, comprises the steps of:
wherein a specific user account accesses the function for facilitating market participation between buyers and sellers during step (G), and wherein the specific user account is one of the plurality of user accounts;
providing an overall industry designation for each user account;
prompting each user account to enter a marketplace posting through the corresponding PC device;
receiving the marketplace posting from the specific user account through the corresponding PC device, wherein the marketplace posting is associated to a specific industry; and
displaying the marketplace posting to at least one other user account through the corresponding PC device,
if the specific industry of the marketplace posting matches the overall industry designation of the other user account,
wherein the other user account is one of the plurality of user accounts.

5. The method for managing a smart enterprise network, as claimed in claim 1, comprises the steps of:
wherein a specific user account accesses the function for facilitating transactions for technology and services during step (G), and wherein the specific user account is one of the plurality of user accounts;
providing an overall industry designation for each user account;
providing a plurality of marketplace postings managed by the central server, wherein each marketplace posting is associated to a specific industry and to a corresponding user account from the plurality of user accounts;
searching for viewable postings from the plurality of marketplace postings with the central server, wherein the specific industry of each viewable posting matches the overall industry designation of the specific user account;
displaying the viewable postings through the corresponding PC device of the specific user account;
prompting the specific user account to initiate a transaction for one of the viewable postings through the corresponding PC device;
receiving a posting selection for the specific user account through the corresponding PC device, wherein the posting selection is one of the viewable postings; and
managing the transaction between the specific user account and the corresponding user account of the posting selection with the central server.

6. The method for managing a smart enterprise network, as claim in claim 1, comprises the steps of:
wherein a specific enterprise account accesses the function for correlating internal operational data to the enterprise profile data during step (H), and wherein the specific enterprise account is one of the plurality of enterprise accounts;
providing operational parameters for each enterprise account, wherein the enterprise profile data includes the operational parameters;
receiving a periodic operational report from the corresponding PC device of the specific enterprise account;
comparing operational metrics from the periodic operational report to the operational parameters with the remote server in order to identify at least one outlier within the periodic operational report; and
sending an operational adjustment alert to the corresponding PC device of the specific enterprise account,
if at least one outlier is identified within the periodic operational report.

7. The method for managing a smart enterprise network, as claim in claim 1, comprises the steps of:
wherein a specific enterprise account accesses the function for correlating enterprise profile data to external market data during step (H), wherein the specific enterprise account is one of the plurality of enterprise accounts;
providing industry technology data as a data entry within the enterprise profile data of the specific enterprise account;
providing a plurality of modern technology data stored on the central server;
searching through the modern technology data for the industry technology data of the specific enterprise account with the central server;
recording the industry technology data of the specific enterprise account into the modern technology data with central server,
if the industry technology data is not found amongst the modern technology data,
and if the privacy designation of the industry technology data is public;
sending an obsolete notification for the industry technology data to the corresponding PC device of the specific enterprise account, and
if the industry technology data is found amongst the plurality of modern technology data,
and if the industry technology data is dated before an antiquation threshold.

8. The method for managing a smart enterprise network, as claimed in claim 7, comprises the steps of:
monitoring an external network for a technology-failure notification with the central server;
comparing the technology-failure notification to each modern technology datum with the central server in order to identify a matching datum amongst the plurality of modern technology data;
associating the technology-failure notification to the matching datum with the central server,
if the matching datum is identified amongst the plurality of modern technology data; and
sending the technology-failure notification to the corresponding PC device of the specific enterprise account,
if the matching datum includes the industry technology data of the specific enterprise account.

9. The method for managing a smart enterprise network, as claimed in claim 7, comprises the steps of:
receiving a technology-failure notification through the corresponding PC device of a source account, wherein the source account is one of the plurality of user accounts;
comparing the technology-failure notification to each modern technology datum with the central server in order to identify a matching datum amongst the plurality of modern technology data;
associating the technology-failure notification to the matching datum with the central server,
if the matching datum is identified amongst the plurality of modern technology data; and
sending the technology-failure notification to the corresponding PC device of the specific enterprise account,
if the matching datum includes the industry technology data of the specific enterprise account.

10. The method for managing a smart enterprise network, as claimed in claim 7, comprises the steps of:
providing at least two other enterprise accounts, wherein the at least two other enterprise accounts are from the plurality of enterprise accounts;
receiving a merger notification from each of the at least two other enterprise accounts through the corresponding PC device, wherein the merger notification includes a specific industry of the at least two other enterprise accounts; and
sending the merger notification to the corresponding PC device of the specific enterprise account,
if the specific industry of the merger notification matches the industry technology data of the specific enterprise account.

11. The method for managing a smart enterprise network, as claimed in claim 1, comprises the steps of:
wherein a specific enterprise account accesses the function for correlating enterprise profile data to external market data during step (H);
wherein the enterprise profile data for each enterprise account includes business-method data, industry-technology data, and industry-solutions data;
analyzing the enterprise profile data for each enterprise account with the central server in order to identify business-efficiency trends within the enterprise profile data for each enterprise account; and
sending the business-efficiency trends to the corresponding PC device of the specific enterprise account.
